(19) United States
(12) Patent Application Publication
(10) Pub. No.: US 2026/0087139 A1
(43) Pub. Date: Mar. 26, 2026

(54) VERIFIER DEVICE AND REMOTE ATTESTATION SYSTEM

(71) Applicant: DENSO CORPORATION, Kariya-city (JP)

(72) Inventors: Tomonori IKUSE, Kariya-city (JP); Yasuharu SUGANO, Kariya-city (JP); Madoka ASAI, Kariya-city (JP); Takeshi NAKAMURA, Kariya-city (JP); Carlos MORA-GOLDING, Southfield, MI (US); Ameer KASHANI, Southfield, MI (US)

(21) Appl. No.: 18/894,351

(22) Filed: Sep. 24, 2024

(51) Int. Cl. G06F 21/57

(52) U.S. Cl. CPC G06F 21/57; G06F 2221/033

(57) ABSTRACT

A verifier device in a remote attestation system is provided. The prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, and the verifier device requests additional evidence data. The verifier device is configured to determine an address specifying a position of the additional evidence data based on the evidence data; determine an acquisition range of the additional evidence data to be additionally collected based on the address; generate an additional evidence collection instruction including the acquisition range; transmit the additional evidence collection instruction to the prover device; and receive the additional evidence data from the prover device.

### TECHNICAL FIELD

The present disclosure relates to a verifier device that further requests additional evidence data based on evidence data transmitted from a prover device to the verifier device in a remote attestation system where the verifier device verifies the integrity of software executed by the prover device. As an example, the present disclosure relates to a remote attestation system in which all or some of devices constituting the system are mounted in a vehicle.

### BACKGROUND

Related art discloses a remote attestation scheme that verifies the integrity of processes and systems in execution. In Patent Literature 1, a prover acquires a start address, a size, and a measurement result of a memory region of a process or a system, and transmits the acquired start address, size, and measurement result to a verifier. The verifier verifies the integrity of the prover by comparing a correct value prepared in advance or a correct value calculated based on the received information with the received measurement result.

### SUMMARY

A verifier device in a remote attestation system is provided. The prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, and the verifier device requests additional evidence data. The verifier device is configured to determine an address specifying a position of the additional evidence data based on the evidence data; determine an acquisition range of the additional evidence data to be additionally collected based on the address; generate an additional evidence collection instruction including the acquisition range; transmit the additional evidence collection instruction to the prover device; and receive the additional evidence data from the prover device.

### BRIEF DESCRIPTION OF THE DRAWINGS

The objects, features, and advantages of the present disclosure will become more apparent from the following detailed description made with reference to the accompanying drawings. In the drawings:

FIGS. 1A to 1C are explanatory diagrams illustrating the arrangement of a prover device, a verifier device, and a remote attestation system;

FIG. 2 is an explanatory diagram illustrating the arrangement of the prover device and the verifier device in a vehicle;

FIG. 3 is a block diagram illustrating a configuration example of the prover device according to the first embodiment;

FIGS. 4A and 4B are explanatory diagrams illustrating a measurement instruction received by a measurement instruction reception unit and processing contents of a measurement unit;

FIG. 5 is a block diagram illustrating a configuration example of a verifier device according to the first embodiment;

FIGS. 6A and 6B are explanatory diagrams illustrating information stored in advance in the storage unit of the verifier device;

FIG. 7 is an explanatory diagram illustrating a measurement instruction transmitted from the verifier device to the prover device;

FIG. 8 is an explanatory diagram illustrating a measurement result transmitted from the verifier device to the prover device;

FIG. 9 is an explanatory diagram illustrating an evidence request instruction transmitted from the verifier device to the prover device;

FIG. 10 is an explanatory diagram illustrating evidence data transmitted from the prover device to the verifier device;

FIGS. 11A and 11B are explanatory diagrams illustrating a method of analyzing a type and a tampered portion and extracting an address;

FIGS. 12A to 12C are explanatory diagrams illustrating a method for determining an acquisition range of additional evidence data;

FIG. 13 is an explanatory diagram illustrating an example of a memory map;

FIG. 14 is an explanatory diagram illustrating an additional evidence request instruction transmitted from the verifier device to the prover device; and

FIG. 15 is a flowchart illustrating the operation of the verifier device according to the first embodiment.

### DETAILED DESCRIPTION

In recent years, various electronic control devices connected through in-vehicle networks are mounted in automobiles, and software is executed in each electronic control device. However, there is a possibility that such software may be tampered with by a cyberattack or the like due to being compromised, causing the software to operate differently from the original plan. To address these issues, the use of remote attestation is being considered. Remote attestation is a mechanism that can confirm the integrity of a device or software on the device during remote operation or the like for the purpose of device management and operation.

As a result of detailed studies, the present inventor has found the following problems.

It is conceivable that, after the remote attestation disclosed in the related art, raw data of a memory region is collected as evidence data for the purpose of forensics, that is, investigation and analysis. In this case, it is possible to analyze what kind of tampering has been made to the raw data and what kind of problem the tampering causes. For example, if an instruction to be executed has been rewritten as nop (no operation), it can be seen that the function to be originally operated is disabled.

However, such a procedure may not be able to collect sufficient evidence data. For example, if only a fragment of attack code is embedded by tampering, such as an inline hook in an application programming interface (API), tampering of a instruction can be identified by the evidence data. However, since the hook function itself is not included in the evidence data, it is not possible to analyze the details of what kind of problem is caused.

Therefore, an object of the present disclosure is to implement a verifier device and a remote attestation system capable of collecting evidence necessary and sufficient for analysis by collecting additional evidence data as necessary while analyzing evidence data.

According to one aspect of the present disclosure, a verifier device in a remote attestation system comprising a prover device and the verifier device is provided. The prover device transmits a measurement result in response to a measurement instruction from the verifier device. The verifier device transmits an evidence collection instruction requesting evidence data in response to the measurement result from the prover device. The prover device transmits the evidence data in response to the evidence collection instruction from the verifier device. The verifier device that has received the evidence data requests additional evidence data. The verifier device includes: an address determination unit that determines an address specifying a position of the additional evidence data based on the evidence data; an additional evidence data acquisition range determination unit that determines an acquisition range of the additional evidence data to be additionally collected based on the address; an additional evidence collection instruction generation unit that generates an additional evidence collection instruction including the acquisition range; an additional evidence collection instruction transmission unit that transmits the additional evidence collection instruction to the prover device; and an additional evidence data reception unit that receives the additional evidence data from the prover device.

With the above configuration, the verifier device and the like according to the present disclosure extracts an address indicating a transition destination or a reference destination included in evidence data, and determines an acquisition range of additional evidence data based on the extracted address, so that evidence necessary and sufficient for analysis can be collected.

Hereinafter, embodiments of the present disclosure will be described with reference to the drawings.

When there are a plurality of embodiments (including modifications), the configuration disclosed in each embodiment is not closed only by each embodiment, but can be combined across embodiments. For example, the configuration disclosed in one embodiment may be combined with another embodiment. The configurations disclosed respectively in a plurality of embodiments may be collected and combined.

### 1. Premise of Each Embodiment

### (1) Arrangement of Prover Device 100, Verifier Device 200, and Remote Attestation System 1

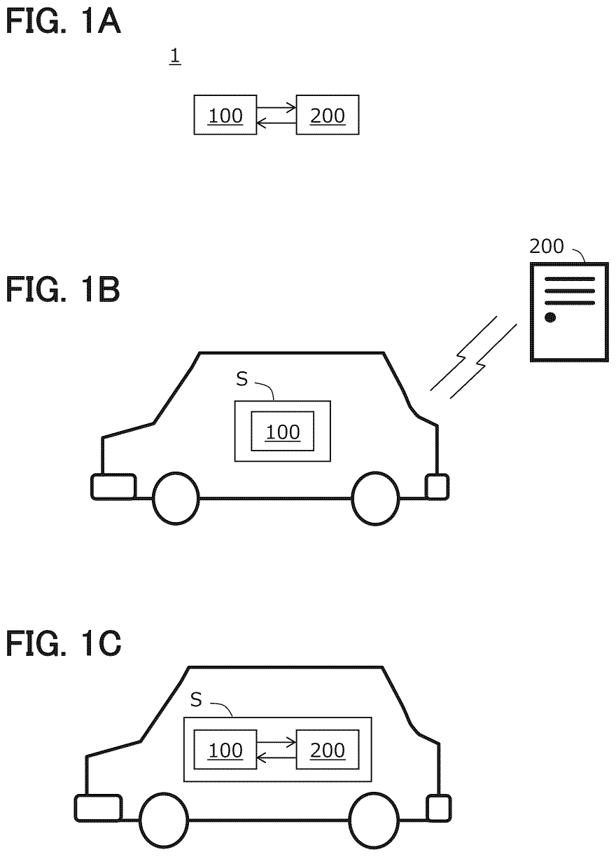

FIGS. 1A to 1C are diagrams illustrating the arrangement of a prover device 100, a verifier device 200, and a remote attestation system 1. First, an outline of each device and its connection method will be described with reference to FIG. 1A.

The prover device 100 is a device that places “software” in “memory” and executes the software. This device is a device that is a target for proving the integrity of the software executed, that is, a device that provides evidence information for proving its own integrity. Therefore, the device is referred to as a prover device.

The verifier device 200 is a device that verifies the integrity of “software” executed by the prover device 100, that is, a device that verifies the integrity of the prover device based on the evidence information received from the prover device. Therefore, the device is referred to as a verifier device.

The prover device 100 and the verifier device 200 are collectively referred to as the remote attestation system 1.

The “software” includes not only a case where the software is made up of program code and data but also a case where the software is made up of only program code or only data.

For the “memory”, a position-identifiable readable/writable recording medium is sufficient, which may include nonvolatile memory such as flash memory or a hard disk, in addition to volatile memory such as random-access memory.

The prover device 100 and the verifier device 200 are connected using a wired communication method or a wireless communication method to transmit and receive a measurement instruction, a measurement result, an evidence collection instruction, evidence data, an additional evidence collection instruction, additional evidence data, and the like, which will be described later.

Examples of the wired communication method include the Internet, a fixed telephone line, and Ethernet (registered trademark). When an in-vehicle network is used, a controller area network (CAN) or a local interconnect network (LIN) can be used.

Examples of the wireless communication method include IEEE802.11 (Wi-Fi (registered trademark)), IEEE802.16 (WiMAX (registered trademark)), wideband code division multiple access (W-CDMA), high-speed packet access (HSPA), long-term evolution (LTE), long-term evolution advanced (LTE-A), fourth generation (4G), fifth generation (5G), and the like. In addition, dedicated short-range communication (DSRC), Bluetooth low energy (BLE), or Bluetooth (registered trademark) may be used.

As to which communication method to use, it is sufficient to adopt an optimal communication method according to the positions at which the prover device 100 and the verifier device 200 are installed, the distance therebetween, and other factors.

The communication between the prover device 100 and the verifier device 200 is desirably protected by a secure communication protocol such as mTLS.

The positions where the prover device 100 and the verifier device 200 are disposed are arbitrary. That is, the positions of the prover device 100 and the verifier device 200 and the distance between the prover device 100 and the verifier device 200 are arbitrary.

For example, as illustrated in FIG. 1B, the prover device 100 may be mounted in a vehicle, and the verifier device 200 may be provided outside the vehicle. For example, the prover device 100 may be an “electronic control device” (electric control unit, ECU) “mounted” in a vehicle that is a “moving object”, and the verifier device 200 may be a server device installed outside the vehicle that is the “moving object”. That is, the prover device 100 is located inside an electronic control system S, and the verifier device 200 is located outside the electronic control system S. The electronic control device is a device constituting the electronic control system of the vehicle. In this case, the prover device 100 and the verifier device 200 are connected by, for example, Wi-Fi or 5G.

Alternatively, as illustrated in FIG. 1C, both the prover device 100 and the verifier device 200 may be mounted in the vehicle. For example, the prover device 100 may be an “electronic control device” “mounted” in the vehicle that is the “moving object”, and the verifier device 200 may be another “electronic control device” “mounted” in the vehicle that is the “moving object”. That is, both the prover device 100 and the verifier device 200 are located inside the electronic control system S. In this case, the prover device 100 and the verifier device 200 are connected by Ethernet or CAN.

In addition, both the prover device 100 and the verifier device 200 may be provided outside the vehicle, regardless of which vehicle.

The “moving object” refers to a movable object, and a moving speed is arbitrary. Naturally, a case where the moving object is stopped is also included. Examples thereof include, but are not limited to, an automobile, a motorcycle, a bicycle, a pedestrian, a ship, an aircraft, and an object mounted therein.

The term “mounted” includes not only a case where the device is directly fixed to the moving object but also a case where the device is not fixed to the moving object but moves together with the moving object. Examples thereof include a case where a person on the moving object carries the device and a case where the device is mounted in a load placed on the moving object.

The “electronic control device” may be a virtualized electronic control device implemented using virtualization technology, in addition to a physically independent electronic control device.

In each embodiment to be described later, a description will be given on the premise of the arrangement of FIG. 1B.

### (2) Arrangement of Prover Device 100 and Verifier Device 200 in Vehicle

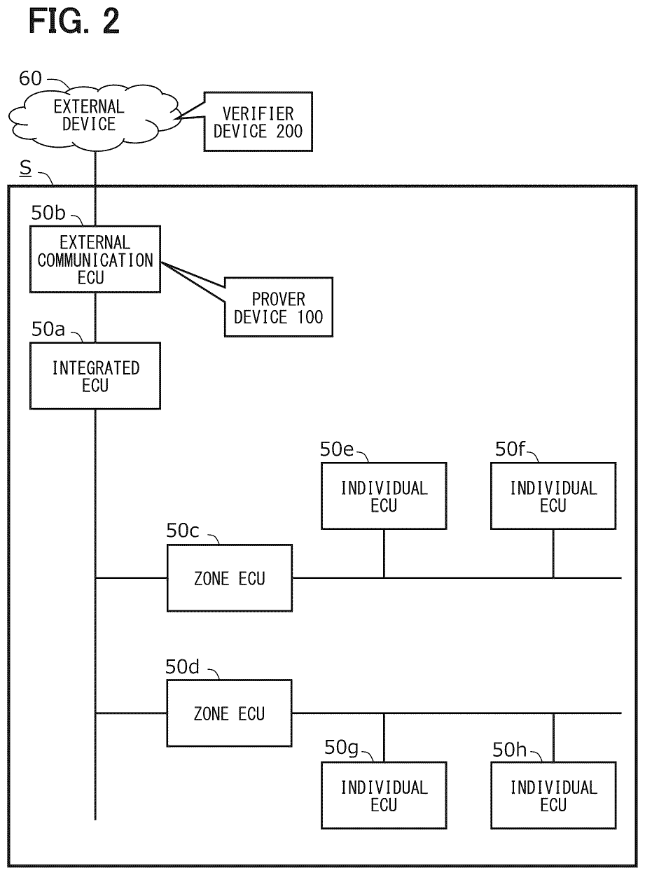

FIG. 2 is a diagram illustrating the electronic control system S mounted in the vehicle and an example of the arrangement of the prover device 100 and the verifier device 200 in the electronic control system S.

The electronic control system S includes a plurality of ECUs 50 and an in-vehicle network that connects these ECUs. FIG. 2 illustrates eight ECUs (ECU 50a to ECU 50h), but naturally, the electronic control system S includes any number of ECUs. In the following description, ECU 50 or each ECU 50 is used to collectively describe one or more electronic control devices as a whole, and ECU 50a, ECU 50b, ECU 50c, . . . are used to identify and describe individual electronic control devices.

In the case of FIG. 2, the ECUs 50 are connected via an in-vehicle communication network such as a controller area network (CAN) or a local interconnect network (LIN). Alternatively, the connection may be made using any wired or wireless communication method, such as Ethernet (registered trademark), Wi-Fi (registered trademark), or Bluetooth (registered trademark).

The connection refers to a state where data can be exchanged and includes not only a case where different pieces of hardware are connected via a wired or wireless communication network, but also a case where virtual ECUs (also referred to as virtual machines) implemented on the same hardware are connected to each other virtually.

The electronic control system S illustrated in FIG. 2 includes an integrated ECU 50a, an external communication ECU 50b, zone ECUs (50c, 50d), and individual ECUs (50e to 50h).

The integrated ECU 50a is an ECU equipped with a function to control the entire electronic control system S and a gateway function to mediate communication between the ECUs 50. The integrated ECU 50a may also be referred to as a gateway ECU (G-ECU) or a mobility computer (MC). The integrated ECU 50a may be a relay device or a gateway device.

The external communication ECU 50b is an ECU including a communication unit that communicates with an external device 60 provided outside the vehicle. The communication method used by the external communication ECU 50b is the wireless communication method or the wired communication method described in FIGS. 1A to 1C.

To implement a plurality of communication methods, a plurality of external communication ECUs 50b may be provided. Instead of providing the external communication ECU 50b, the integrated ECU 50a may include the function of the external communication ECU 50b.

The zones ECU (50c, 50d) are ECUs equipped with gateway functions appropriately disposed according to the arrangement places and functions of the individual ECUs (50e to 50h). For example, the zone ECU 50c is an ECU with a gateway function that mediates communication between the individual ECU 50e and the individual ECU 50f arranged in the front of the vehicle and another ECU 50. The zone ECU 50d is an ECU with a gateway function that mediates communication between the individual ECU 50g and the individual ECU 50h arranged in the rear of the vehicle and another ECU 50.

The individual ECUs (50e to 50h) can be configured by ECUs with any function. Examples thereof include: a drive system electronic control device that controls the engine, steering wheel, brake, and the like; a vehicle body system electronic control device that controls the meter, power window, and the like; an information system electronic control device such as a navigation device; and a safety control system electronic control device that performs control to prevent collision with obstacles or pedestrians. The ECUs 50 may not be arranged in parallel, and may be classified into a master and a slave.

Each ECU 50 stores software corresponding to its function and reads the software into memory for execution as necessary. Accordingly, each ECU 50 can be the prover device 100.

In the following embodiment, a case where the external communication ECU 50b is the prover device 100 in FIG. 2 will be described as an example. This is because the external communication ECU 50b is located in the shallowest layer in the electronic control system and is thus vulnerable to attack and at high risk of program rewriting, so that the external communication ECU 50b often acts as a prover device.

When the verifier device 200 is provided outside the vehicle as illustrated in FIG. 1B, the external device 60 of FIG. 2 is the verifier device 200. When the verifier device 200 is mounted in the vehicle as illustrated in FIG. 1C, for example, the integrated ECU 50a can be set as the verifier device 200.

In the following embodiment, in FIG. 2, a case where the external device 60 is the verifier device 200 will be described as an example.

### 2. First Embodiment

### (1) Configuration of the Prover Device 100

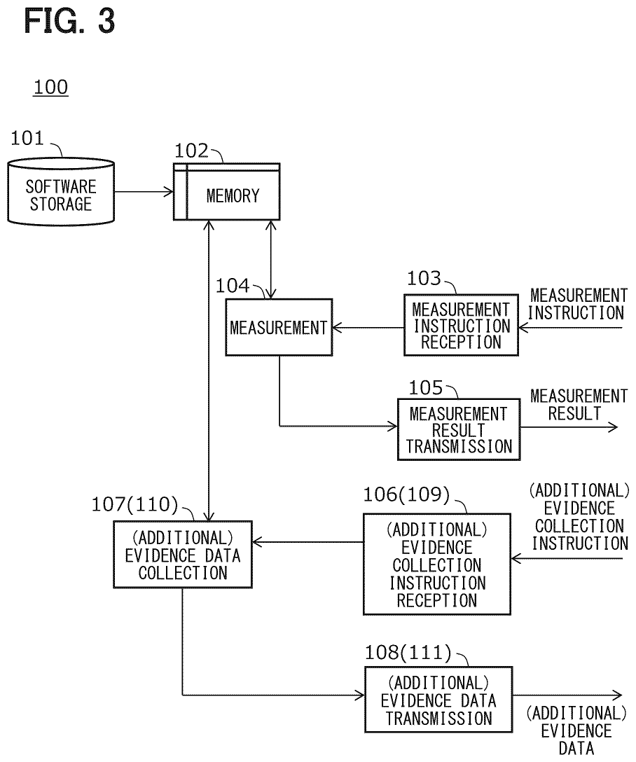

A configuration example of the prover device 100 according to the present embodiment will be described with reference to FIG. 3. The prover device 100 includes a software storage unit 101, a memory 102, a measurement instruction reception unit 103, a measurement unit 104, a measurement result transmission unit 105, an evidence collection instruction reception unit 106, an evidence data collection unit 107, an evidence data transmission unit 108, an additional evidence collection instruction reception unit 109, an additional evidence data collection unit 110, and an additional evidence data transmission unit 111.

The prover device 100 can include a general-purpose central processing unit (CPU), volatile memory such as random-access memory (RAM), nonvolatile memory such as read-only memory (ROM), flash memory, or a hard disk, various interfaces, and internal bus that connects these components. By executing software on these pieces of hardware, it is possible to perform the function of each functional block illustrated in FIG. 3. The same applies to the verifier device 200 to be described later.

The prover device 100 reads the software stored in the software storage unit 101 into the memory 102 to place the software in the memory and execute the software. The placement position of the software in the memory may be either the same at all times or different at each reading. When the position is different for each reading, it is desirable to share the placement position with the verifier device 200. When the memory 102 is a random-access memory (RAM), the placement position can be indicated by, for example, a start address indicating the leading position of the software and the size of the software. The size of the software may be omitted when the size of the software is known in the verifier device 200. Alternatively, the placement position is a start address indicating the leading position and an end address indicating the trailing position.

The measurement instruction reception unit 103 receives a measurement instruction generated by the verifier device 200 from the verifier device 200. In the present embodiment, the measurement instruction includes measurement region information indicating a region to be measured in the software. The measurement region information only needs to be information that can specify all or a part of the software in the memory, and examples thereof include an address and a size.

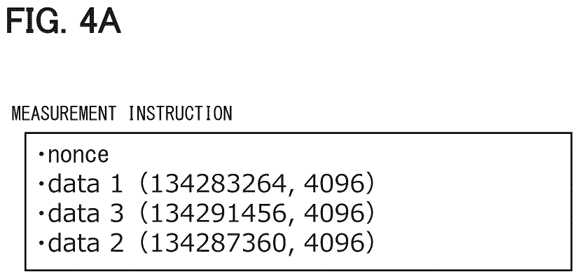

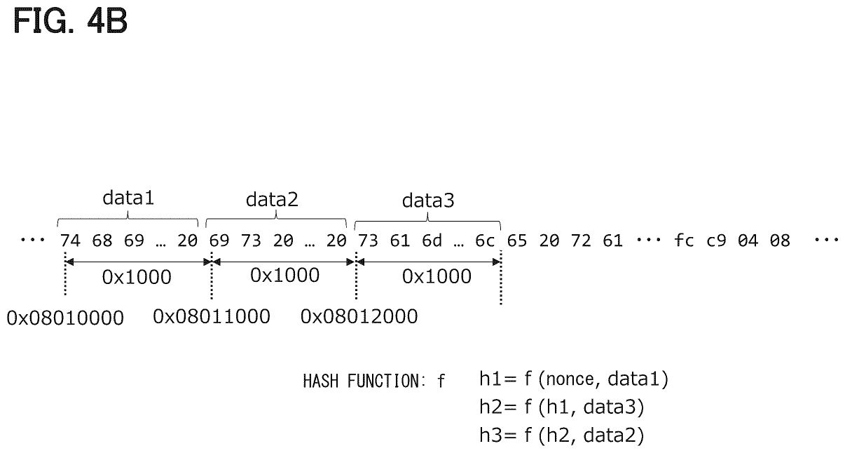

A specific example of the measurement instruction received by the measurement instruction reception unit 103 will be described with reference to FIGS. 4A and 4B. In the case of FIG. 4A, the received measurement instruction includes three regions as measurement region information in addition to a nonce. The first region is indicated by data1, with a start address of 134283264 (decimal notation), and a size of 4096 bytes. The second region is indicated by data3, with a start address of 134291456 (decimal notation), and a size of 4096 bytes. A third region is indicated by data2, with a start address of 134287360 (decimal notation), and a size of 4096 bytes.

This measurement instruction also includes an instruction to execute measurement in the order of data1, data3, and data2. That is, the order of data1, data3, and data2 corresponds to the measurement order information.

The nonce is, for example, a random number generated by the verifier device 200, but may also be any numerical value with low predictability, even if not completely random.

Based on the measurement instruction received by the measurement instruction reception unit 103, the measurement unit 104 reads software placed in the memory 102 and calculates a measurement value. In the present embodiment, a “hash value” is calculated as the measurement value.

The “hash value” is an output value itself calculated by a function that calculates a unique value for an input value, or a value obtained by performing processing such as encryption on the output value, and an algorithm used for the function is arbitrary. For example, the “hash values” include not only a value calculated by a one-way hash function such as SHA512 but also a value calculated by a cipher-based MAC (CMAC), a value calculated by a hash-based MAC (HMAC), and a signature.

In FIG. 4B, data1 of the software placed in the memory 102 has a start address of 0x08010000 (hexadecimal notation) and a size of 0x1000 (hexadecimal notation), data3 has a start address of 0x08012000 (hexadecimal notation) and a size of 0x1000 (hexadecimal notation), and data2 has a start address of 0x08011000 (hexadecimal notation) and a size of 0x1000 (hexadecimal notation). Therefore, based on the respective arguments, the measurement unit 104 reads the corresponding ranges of the software and calculates the respective hash values as follows:

$$h 1 = f ( nonce , data 1 )$$

$$h 2 = f ( h 1 , data 3 )$$

$$h 3 = f ( h 2 , data 2 )$$

$$( where f is a hash function ) .$$

The start address may be included as the argument of the hash function.

In FIGS. 4A and 4B, the hash value is calculated by dividing the measurement region into three regions based on the measurement region information and the measurement order information included in the measurement instruction. However, if the measurement instruction does not include an instruction to divide the region, the hash value may be calculated using the nonce and the raw data of the software in the memory 102.

The measurement result transmission unit 105 transmits the hash value calculated and obtained by the measurement unit 104 to the verifier device 200 as a measurement result. In the case of FIGS. 4A and 4B, the measurement result transmission unit 105 transmits the hash values h1, h2, h3.

In addition to the hash value, a time when the hash value was obtained and error information indicating the address and size of the region to be measured for which measurement has failed may also be transmitted.

In the present embodiment, the hash values h1, h2, h3 are simultaneously transmitted. However, since h1 and h2 are reflected in the calculation result of h3, h3 may be first transmitted, and h2 and h1 may be sequentially transmitted as necessary.

Based on the measurement result transmitted from the measurement result transmission unit 105, the evidence collection instruction reception unit 106 receives the evidence collection instruction generated by the verifier device 200. For example, when the verifier device 200 detects tampering of software being executed in the memory 102 of the prover device 100, the verifier device 200 generates and transmits, to the prover device 100, an evidence collection instruction for requesting transmission of the software being executed as evidence data. The evidence collection instruction reception unit 106 receives the evidence collection instruction.

Based on the evidence collection instruction received by the evidence collection instruction reception unit 106, the evidence data collection unit 107 collects evidence data. For example, software being executed is collected by being read from the memory 102.

The evidence data transmission unit 108 transmits the collected evidence data to the verifier device 200. When the verifier device 200 is a server device installed outside the vehicle as illustrated in FIGS. 1B and 2, the individual ECU 50f, that is, the prover device 100, outputs evidence data to an in-vehicle network such as CAN, and transmits the evidence data from the external communication ECU 50b via the zone ECU 50 and the integrated ECU 50a. In contrast, when the verifier device 200 is an ECU mounted in the vehicle as illustrated in FIG. 1C, the individual ECU 50f, that is, the prover device 100, outputs evidence data to an in-vehicle network such as CAN.

The additional evidence collection instruction reception unit 109 receives additional evidence collection instruction generated and transmitted by the verifier device 200. Details of the additional evidence collection instruction will be described later.

The additional evidence data collection unit 110 collects the additional evidence data based on the additional evidence collection instruction received by the additional evidence collection instruction reception unit 109. For example, similarly to the evidence data collection unit 107, software being executed is collected by being read from the memory 102.

The additional evidence data transmission unit 111 transmits the collected additional evidence data to the verifier device 200.

The additional evidence collection instruction reception unit 109, the additional evidence data collection unit 110, and the additional evidence data transmission unit 111 have the same functions as the evidence collection instruction reception unit 106, the evidence data collection unit 107, and the evidence data transmission unit 108, respectively, and thus may be combined into one block. That is, as illustrated in FIG. 3, the evidence collection instruction reception unit 106 and the additional evidence collection instruction reception unit 109, the evidence data collection unit 107 and the additional evidence data collection unit 110, and the evidence data transmission unit 108 and the additional evidence data transmission unit 111 may each be implemented as one component or one program.

### (2) Configuration of Verifier Device 200

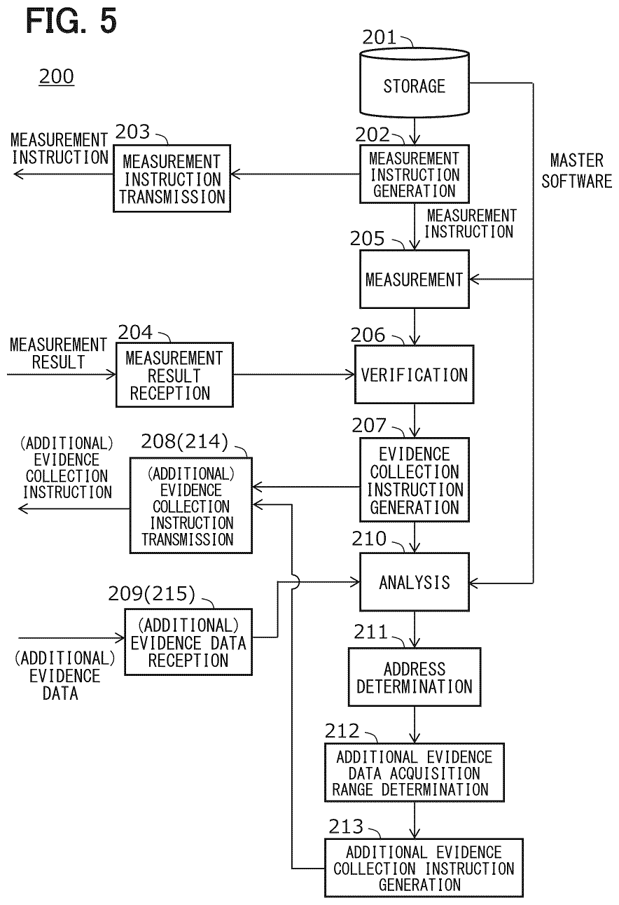

A configuration example of the verifier device 200 according to the present embodiment will be described with reference to FIG. 5. The verifier device 200 includes a storage unit 201, a measurement instruction generation unit 202, a measurement instruction transmission unit 203, a measurement result reception unit 204, a measurement unit 205, a verification unit 206, an evidence collection instruction generation unit 207, an evidence collection instruction transmission unit 208, an evidence data reception unit 209, an analysis unit 210, an address determination unit 211, an additional evidence data acquisition range determination unit 212, an additional evidence collection instruction generation unit 213, an additional evidence collection instruction transmission unit 214, and an additional evidence data reception unit 215.

In the storage unit 201, information regarding software stored or installed in the prover device 100 is stored in advance. Moreover, a copy of the software may be stored. This software is software that is executed in the prover device 100 and is a target of the measurement instruction. Hereinafter, the software stored in the storage unit 201 will be referred to as master software.

The storage unit 201 may be either an external storage device (hard disk, universal serial bus (USB) memory, compact disc (CD)/Blu-ray disc (BD), etc.) or an internal storage device (RAM, etc.). The device may be volatile or nonvolatile.

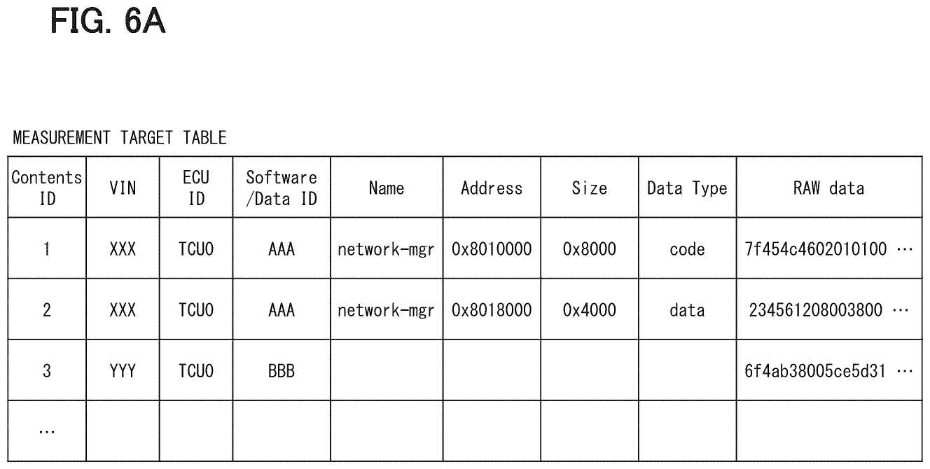

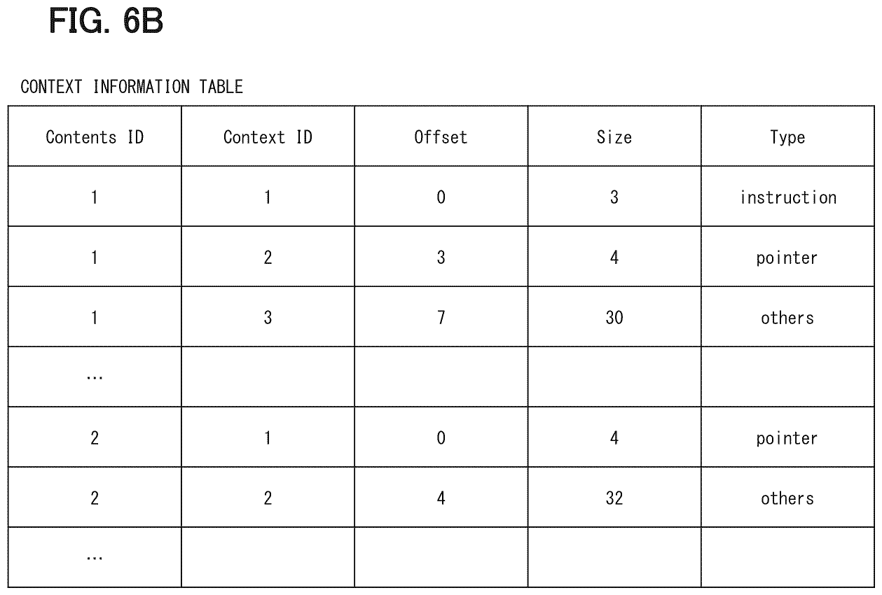

A specific example of the information stored in the storage unit 201 will be described with reference to FIGS. 6A and 6B.

The storage unit 201 stores a measurement target table that records information of software to be measured. As illustrated in FIG. 6A, the measurement target table associates and stores a content identifier (Contents ID) that identifies software, a vehicle identifier (VIN) that identifies a vehicle in which the software is mounted, an identifier (ECU ID) of an ECU in which the software is installed, an identifier (Software/Data ID) that identifies a program or data included in the software, the name (Name) of the software, the start position (Address) of the software in memory, the size (Size) of the software, the data type (Data Type) of the software, and the software itself installed in the prover device 100, that is, raw data (RAW data) of the master software.

The storage unit 201 further stores a context information table that records detailed information of each software to be measured. As illustrated in FIG. 6B, the context information table associates and stores a content identifier (Contents ID) that identifies software, a context identifier (Context ID) that identifies a context, which is a functional element constituting the software, a storage start position (Offset) of data in memory, to which the context is assigned, the size (Size) of the data to which the context is assigned, and the type (Type) of the context. FIG. 6B may be referred to as semantic information. When the data type is code in FIG. 6A, an example in which the context type is an instruction, a pointer, or other cases is described in FIG. 6B. When the data type is data in FIG. 6A, an example in which the context type is a pointer or other cases is described in FIG. 6B. In the present embodiment, the context type in FIG. 6B corresponds to “type”, the instruction corresponds to “instruction”, and the pointer corresponds to “pointer”.

The measurement instruction generation unit 202 generates a measurement instruction for the prover device 100. In the present embodiment, a measurement instruction is generated to instruct the calculation of a hash value that is a measurement value of the software executed by the prover device 100.

In the present embodiment, the measurement instruction includes measurement region information indicating a region to be measured in the software. For example, as in the example of FIG. 4A, the measurement instruction includes a nonce and a plurality of pieces of measurement region information (data1, data3, data2), and also includes measurement order information (data1, data3, data2) indicating an order in which the plurality of pieces of measurement region information are to be processed.

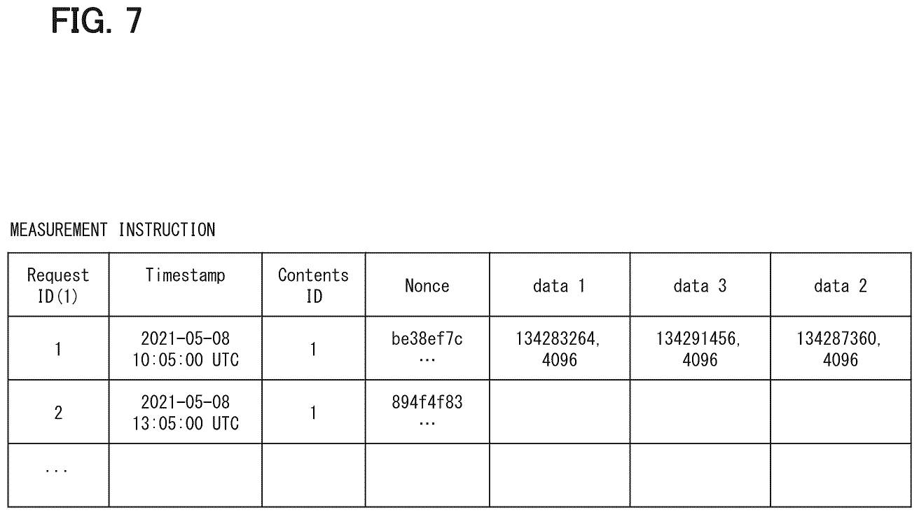

A specific example of the measurement instruction generated by the measurement instruction generation unit 202 will be described with reference to FIG. 7. In the example of FIG. 7, the measurement instruction includes the identifier (Request ID (1)) of the measurement instruction, a time (Timestamp) when the measurement instruction generation unit 202 generates the measurement instruction or when the measurement instruction transmission unit 203 transmits the measurement instruction, a content identifier (Contents ID) that identifies software being executed by the prover device 100, a nonce (Nonce), and measurement region information (data1, data3, data2). When the calculation of the hash value for the entire software is instructed, the measurement region information is unnecessary if the placement of the software is known.

In addition, a vehicle identifier (VIN) that identifies a vehicle, an identifier (ECU ID) of an ECU in which software is installed, and an identifier (Software/Data ID) that identifies a program or data included in executed software may be included.

The measurement instruction transmission unit 203 transmits, to the prover device 100, the measurement instruction generated by the measurement instruction generation unit 202. The timing for transmitting the measurement instruction can be determined arbitrarily. For example, the measurement instruction may be generated and transmitted periodically at regular intervals, or the measurement instruction may be generated and transmitted when an anomaly occurs. Examples of the time when an anomaly occurs include when an anomaly caused by a cyberattack is identified by a vehicle security operation center (SOC) or when a product security incident response team (PSIRT) determines that verification of integrity is necessary. These examples are compatible when the verifier device 200 is provided outside the vehicle. The examples also include when a security sensor such as a host-based intrusion detection system (IDS) or a network-based intrusion detection system (IDS) provided in the electronic control system S of FIG. 2 detects an anomaly or when the in-vehicle security information and event management (SIEM) has finished selecting an anomaly to be examined. These examples are compatible when the verifier device 200 is provided inside the vehicle.

Other examples of the timing include when an ignition power supply is turned off, and when a power supply is turned off in an ECU of a specific group.

The measurement result reception unit 204 receives a measurement result that is the response of the prover device 100 to the measurement instruction transmitted from the measurement instruction transmission unit 203. For example, when the prover device 100 obtains hash values in FIG. 4B by calculation, these hash values h1, h2, h3 are the measurement results.

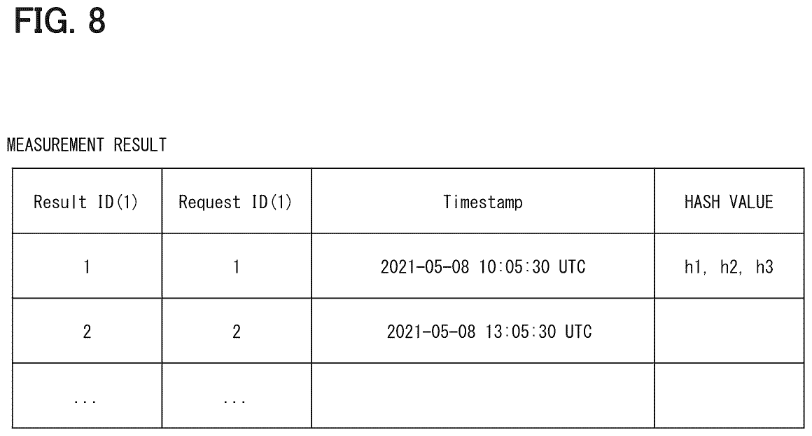

A specific example of the measurement result received by the measurement result reception unit 204 will be described with reference to FIG. 8. In the example of FIG. 8, the measurement result received by the measurement result reception unit 204 includes the identifier (Result ID (1)) of the measurement result, the identifier (Request ID (1)) of the corresponding measurement instruction, a time (Timestamp) when the prover device 100 calculates or transmits the measurement result, and a first hash value that is the measurement result. In the example of FIG. 8, the measurement results are three hash values of h1, h2, and h3. In addition, the measurement result may include a process identification (ID) (PID) of software being executed in the prover device 100.

The measurement unit 205 calculates a second hash value that is the hash value of the master software stored in the storage unit 201. The hash value is calculated based on the nonce and the measurement region information included in the measurement instruction generated by the measurement instruction generation unit 202. The calculation method is the same as that in FIG. 4B.

The verification unit 206 verifies whether the first hash value, which is the measurement result received by the measurement result reception unit 204, matches the second hash value calculated by the measurement unit 205. When the values match, it can be confirmed that the software being executed by the prover device 100 has not been tampered with. When the values do not match, it can be confirmed that the software being executed by the prover device 100 may have been tampered with. The verification unit 206 outputs the verification result to the evidence collection instruction generation unit 207.

The evidence collection instruction generation unit 207 generates an evidence request instruction for requesting necessary evidence data on the basis of the verification result based on the result of the measurement by the verification unit 206. For example, if the software is suspected of having been tampered with, all or part of the software being executed by the prover device 100 is requested as evidence data to prove tampering or take measures against tampering.

For example, if the first hash values h1, h2, h3, which are the measurement results, all differ from the second hash value, there is a possibility that tampering has been made at least in the data1 region, and thus a part of software corresponding to data1 is requested as evidence. If only h3 of the first hash values differs from the second hash value, it is understood that no tampering has been performed in the data1 and data3 regions, and thus a part of software corresponding to data2 is requested as evidence. In the former case, since there is a possibility that tampering is performed in the data3 and data2 regions, the data3 and data2 regions may also be requested as evidence, or all of the software may be requested as evidence.

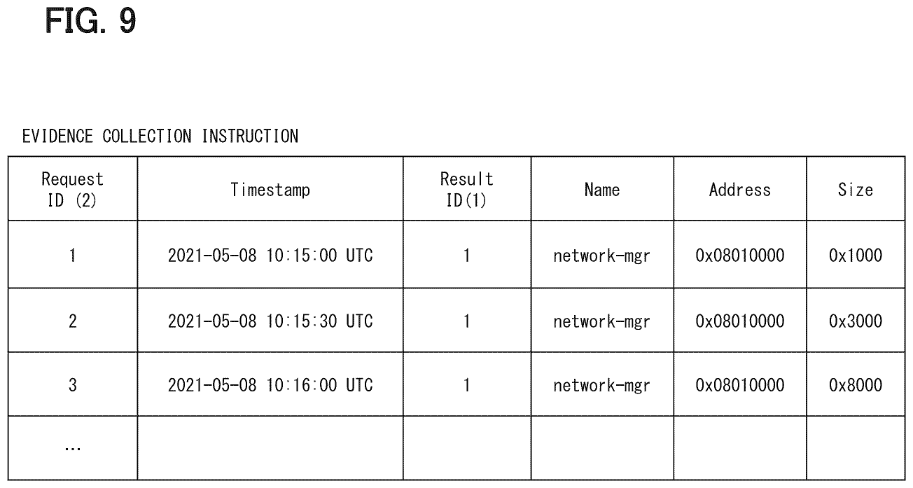

A specific example of the evidence collection instruction generated by the evidence collection instruction generation unit 207 will be described with reference to FIG. 9. In the example of FIG. 9, the evidence collection instruction includes the identifier (Request ID (2)) of the evidence collection instruction, a time (Timestamp) when the evidence collection instruction generation unit 207 generates the evidence collection instruction or when the evidence collection instruction transmission unit 208 transmits the evidence collection instruction, the identifier (Result ID (1)) of the measurement result that has caused the evidence collection instruction to be generated, the name (Name) of the software that is the evidence data to be requested, the start position (Address) of the software in the memory, and the size (Size) of the software.

In FIG. 9, the evidence collection instruction (Request ID (2): 1) in the first row is an example of requesting only data1 in FIG. 4B since the start position and the size of data1 are designated. The evidence collection instruction (Request ID (2): 2) in the second row is an example of requesting data1, data3, and data2 since the start position of data1 and the total size of data1, data3, and data2 are designated. The evidence collection instruction (Request ID (2): 3) on the third line is an example of requesting the entire software since the start position of data1 and the size of the entire target software are designated.

The evidence collection instruction transmission unit 208 transmits, to the prover device 100, the evidence collection instruction generated by the evidence collection instruction generation unit 207.

The evidence data reception unit 209 receives evidence data from the prover device 100. The received evidence data is output to the analysis unit 210.

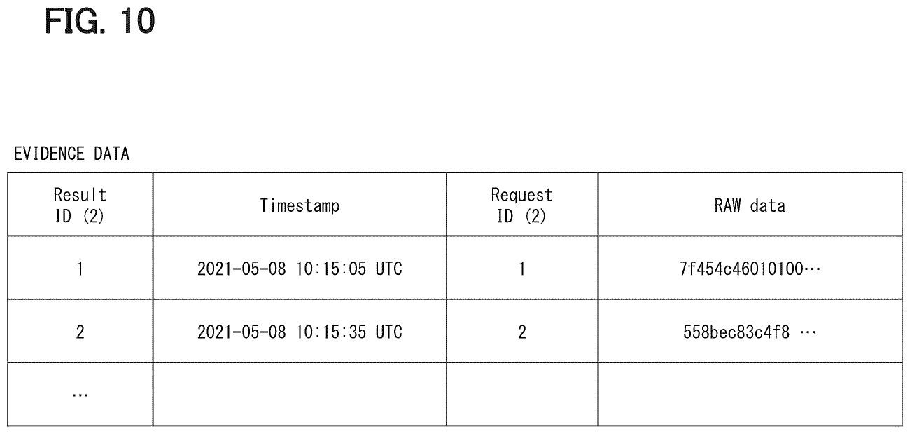

A specific example of the evidence data received by the evidence data reception unit 209 will be described with reference to FIG. 10. In the example of FIG. 10, the evidence data includes the identifier (Result ID (2)) of the evidence data, a time (Timestamp) when the evidence data reception unit 209 receives the evidence data, the identifier (Request ID (2)) of the corresponding evidence collection instruction, and the raw data (RAW data) of the software that is the evidence data.

The analysis unit 210 analyzes the evidence data received by the evidence data reception unit 209. For example, the analysis unit 210 analyzes, based on the evidence data, whether the software has been tampered with and a problem caused if the software has been tampered with. Moreover, an attack that has caused tampering may be identified, and a countermeasure against the attack may be executed.

In the present embodiment, the analysis unit 210 analyzes the “type” and “tampered portion” of the evidence data or additional evidence data to be described later. For the type of evidence data or additional evidence data, it is sufficient to use information acquired in advance by the verifier device 200 may be used for the measurement instruction. For example, semantic information as illustrated in FIG. 6B obtained at the time of compilation and an address table are exemplified. Alternatively, the type of evidence data or additional evidence data may be determined and acquired by likelihood determination or signature of the result of disassembly.

The “type” refers to an instruction or a pointer.

The “tampered portion” is a portion with the content of the evidence data different from the original content, and includes intentional deletions, changes (including overwriting), or additions, as well as unintentional rewrites due to accidents or malfunctions.

Based on the evidence data received by the evidence data reception unit 209, the address determination unit 211 determines an “address” that identifies the position of the additional evidence data. In the present embodiment, the address determination unit 211 determines the address by extracting an “address” indicating a transition destination or a reference destination included in the evidence data received by the evidence data reception unit 209. Moreover, the address determination unit 211 may determine the address by extracting an “address” included in additional evidence data received by the additional evidence data reception unit 215 to be described later.

The “address” only needs to be information indicating the position of the prover device in the memory, and may directly or indirectly designate an address. The address includes a pointer when being referred to in that manner.

In the present embodiment, when the type of the evidence data or additional evidence data in the tampered portion is “instruction”, the address determination unit 211 disassembles the evidence data or additional evidence data to acquire an address. When the type of the evidence data or additional evidence data in the tampered portion is “pointer”, the address determination unit 211 sets the pointer as an address.

The address determination unit 211 may extract a plurality of addresses from evidence data or additional evidence data.

The “instruction” refers to an instruction to execute a particular operation, for example, an arithmetic operation, a memory operation, or a control flow, and is referred to as a mnemonic, for example, in assembly language.

The “pointer” refers to a transition destination of a control flow or a reference destination of data, and is included in an operand, for example, in the case of an assembly language.

The address extracted by the address determination unit 211 is an address indicating a transition destination or a reference destination. The present embodiment specifically targets an address of a hooking function to be called on a “hook”. Whether the address indicates the transition destination or the reference destination may be determined based on whether an instruction that makes the address the processing target is an instruction related to the transition destination or the reference destination. For example, in assembly language, when the mnemonic is a mov instruction or a jmp instruction, the address described in the operand is the address indicating the transition destination or the reference destination. In addition, since a combination of the call instruction, the push instruction, and the ret instruction is an instruction that can change the control flow similarly to the mov instruction and the jmp instruction, the address described in the operand is likely to be the address indicating the transition destination or the reference destination.

An immediate value and a register that are not related to an address may be described in the operand, but when these do not indicate an address, there is no address to be extracted.

The “hook” refers to a mechanism for adding processing to a specific portion of program code, and includes not only an inline hook but also a hook targeting an address table, such as an import address table hook or a system service dispatch table hook.

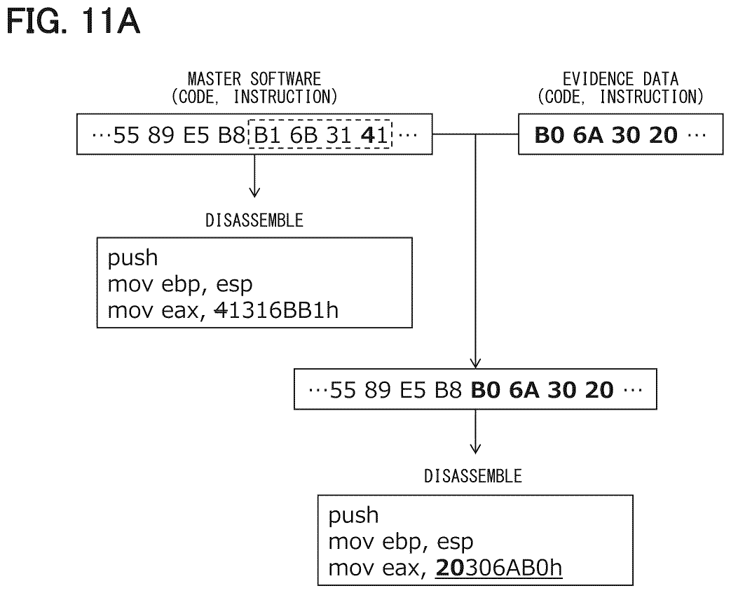

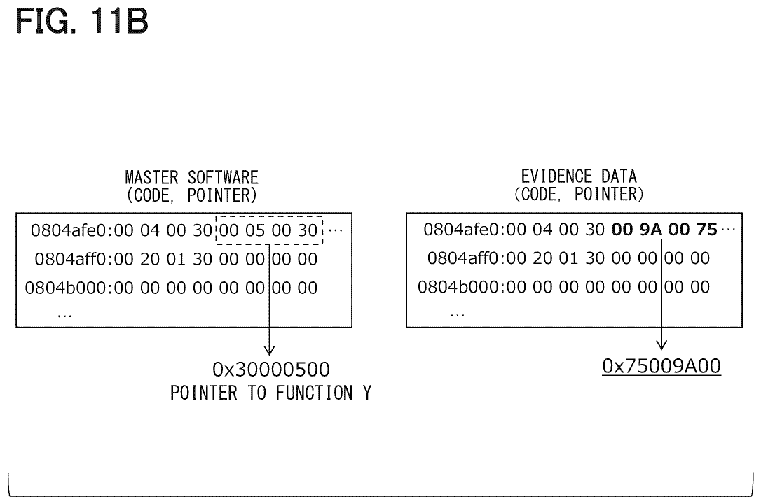

An example of the operation of the analysis unit 210 and the address determination unit 211 will be described with reference to FIGS. 11A and 11B. First, a case where the type is an instruction (corresponding to “instruction”) will be described with reference to FIG. 11A.

The analysis unit 210 compares the master software stored in the storage unit 201 with the evidence data received by the evidence data reception unit 209 to identify which part of the software being executed by the prover device 100 has been tampered with. In FIG. 11A, in the master software, the part that was B1 6B 31 41 has been tampered with and changed to B0 6A 30 20 in the evidence data.

Next, the analysis unit 210 determines, based on the semantic information of FIG. 6B, whether the tampered portion is an instruction or a pointer. In FIG. 11A, it is assumed that the tampered part is determined to correspond to an instruction in the code.

The analysis unit 210 overlays and disassembles the master software and the evidence data. Then, compared to the case where only the master software is disassembled, it can be seen that the address described as the immediate value in the operand of the mov instruction has been rewritten from 41316BB1h to 20306AB0h. Therefore, the address determination unit extracts 20306AB0h as the address indicating the transition destination or the reference destination.

Instead of overlaying and disassembling the master software and the evidence data, software and evidence data acquired from the prover device 100 in the past may be combined and disassembled.

Next, a case where the type is a pointer (corresponding to “pointer”) will be described with reference to FIG. 11B.

The analysis unit 210 compares the master software stored in the storage unit 201 with the evidence data received by the evidence data reception unit 209 to identify which part of the software being executed by the prover device 100 has been tampered with. In FIG. 11B, in the master software, the part that was 00 05 00 30 has been tampered with and changed to 00 9A 00 75 in the evidence data.

Next, the analysis unit 210 determines, based on the semantic information of FIG. 6B, whether the tampered portion is an instruction or a pointer. In FIG. 11B, it is assumed that the tampered part is determined to correspond to a pointer in the code.

The analysis unit 210 analyzes how the transition destination or the reference destination of the pointer of the tampered part has been tampered with. Then, it can be seen that the pointer of the master software indicates function Y at the address 0x30000500, while the pointer of the evidence data indicates an unknown function at the address 0x75009A00. Therefore, the address determination unit extracts 0x75009A00 as the address indicating the transition destination or the reference destination.

In the present embodiment, the address determination unit 211 has extracted and determined the address indicating the transition destination or the reference destination included in the evidence data, but the method of determining the address is not limited to the extraction from the evidence data.

For example, it is assumed that the analysis of the evidence data by the analysis unit 210 reveals that the global variable of the software has been tampered with. A global variable is a variable that can be commonly referred to from a function in software. The address determination unit 211 determines, based on the analysis result of the master software, an address that identifies a start position of a program region where a function for accessing the global variable is placed.

Alternatively, it is assumed that the analysis of the evidence data by the analysis unit 210 reveals that a predetermined region of the evidence data has been tampered with. When the predetermined region that has been tampered with is missing from the middle, the address determination unit 211 determines an address that identifies the start position of the missing region. For example, when the analysis of the evidence data reveals that the measurement region designated by the measurement instruction has been tampered with up to the end, the address following the end is determined as the address that identifies the start position of the missing region.

In this manner, the address determination unit 211 only needs to be able to determine, based on the analysis result of the analysis unit 210, the address that identifies the position of the additional evidence data.

The additional evidence data acquisition range determination unit 212 determines an acquisition range of additional evidence data to be additionally collected based on the address determined by the address determination unit 211.

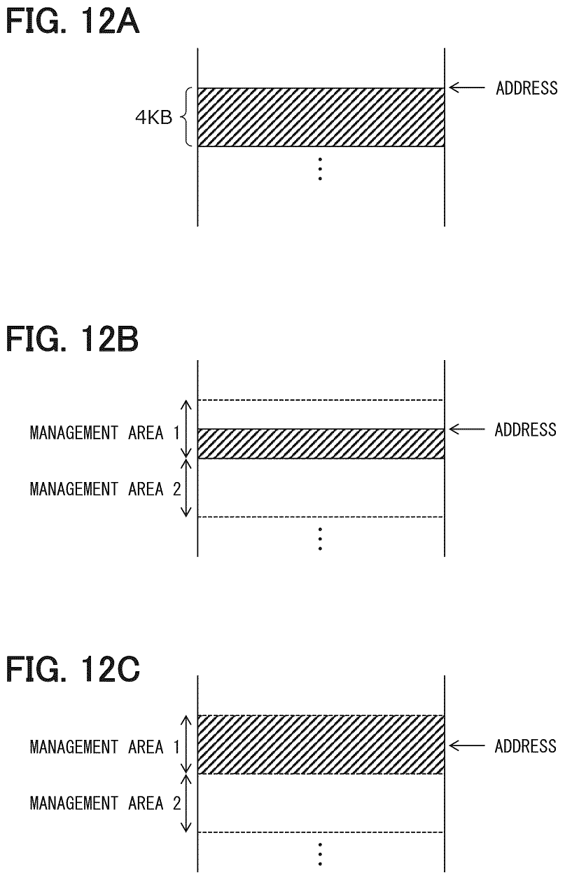

A specific example of the method for determining an acquisition range of additional evidence data will be described with reference to FIGS. 12A to 12C. In FIGS. 12A to 12C, a hatched portion indicates an acquisition range of additional evidence data.

For example, as illustrated in FIG. 12A, the additional evidence data acquisition range determination unit 212 may set the extracted address as the start point of the acquisition range, and may set a value obtained by adding a predetermined size to the address, for example, a value obtained by adding 4 KB, as the end point of the acquisition range.

Alternatively, as illustrated in FIG. 12B, the additional evidence data acquisition range determination unit 212 may set the extracted address as the start point of the acquisition range and set the end point of the memory management region including the extracted address as the end point of the acquisition range.

Alternatively, as illustrated in FIG. 12C, the additional evidence data acquisition range determination unit 212 may set the start point of a memory management region including the extracted address as the start point of the acquisition range, and may set the end point of the memory management region including the extracted address as the end point of the acquisition range.

The memory management region is a continuous region in the memory where the prover device 100 serves as a management unit for programs and data, and is referred to as a segment or a section, for example. The memory management region can be known using a memory map shared by the prover device 100 and the verifier device 200.

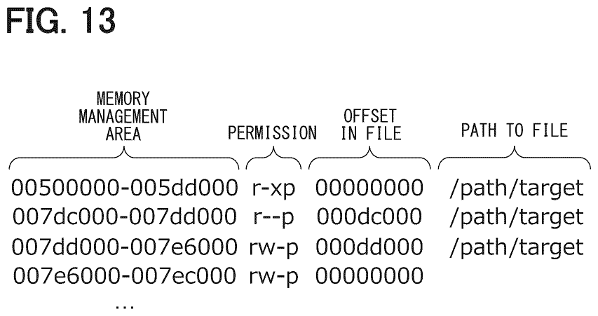

FIG. 13 illustrates an example of the memory map. The memory map includes a memory management region indicating a memory region, a permission, an in-file offset, and a path to a file. In the present embodiment, the memory management region is referred to among these.

For example, when the extracted address is 0x007dc135, the memory management region including the extracted address is a region defined by a start point of 0x007dc000 and an end point of 0x007dd000. That is, in the case of FIG. 12B, the acquisition range has a start point of 0x007dc135 and an end point of 0x007dd000. In the case of FIG. 12C, the acquisition range has a start point of 0x007dc000 and an end point of 0x007dd000.

In the case of FIG. 12A, the acquisition range can be determined independently of the memory map, and hence this case is applicable when the memory map cannot be acquired. That is, the acquisition range can be determined even if the memory map cannot be acquired.

In contrast, the case of FIG. 12B or 12C is applicable when the memory map can be acquired.

Returning to FIGS. 11A and 11B, there is a possibility that a hook function placed by the attacker may have been stored, starting with the address 20306AB0h described in the operand of the mov instruction. Therefore, the additional evidence data acquisition range determination unit 212 determines a 4 KB region starting from the address 20306AB0h as the acquisition range, for example. Since the memory region starting from the address 20306AB0h is a region that cannot be a measurement instruction target because the region is placed in a memory region dynamically allocated by an attack on the prover device. That is, since the hook function is placed in a memory region different from the evidence data, it is necessary to acquire the hook function as additional evidence data.

The additional evidence collection instruction generation unit 213 generates an additional evidence collection instruction including the acquisition range determined by the additional evidence data acquisition range determination unit 212.

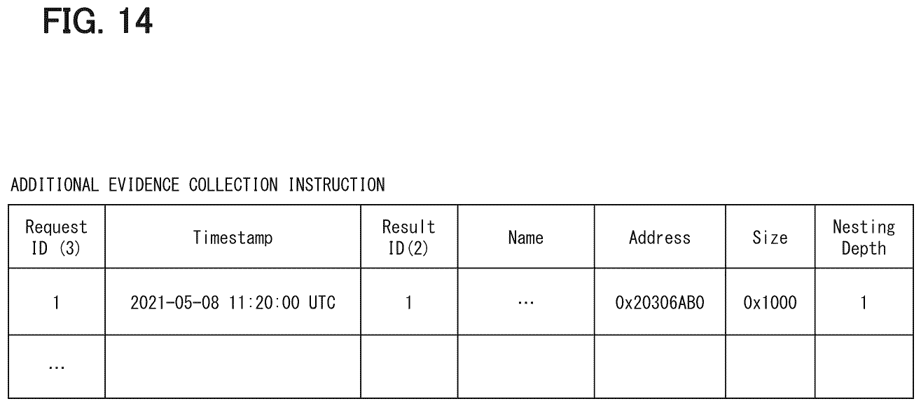

A specific example of the additional evidence collection instruction generated by the additional evidence collection instruction generation unit 213 will be described with reference to FIG. 14. The additional evidence collection instruction is basically in the same form as the evidence collection instruction described in FIG. 9, but further includes the number of times (Nesting depth) additional evidence data was acquired.

That is, in the example of FIG. 14, the additional evidence collection instruction includes the identifier (Request ID (3)) of the additional evidence collection instruction, a time (Timestamp) when the additional evidence collection instruction generation unit 207 generates the additional evidence collection instruction or when the additional evidence collection instruction transmission unit 214 transmits the additional evidence collection instruction, the evidence data or its identifier (Result ID (2)), the evidence data having caused the generation of the additional evidence collection instruction, the name (Name) of the software that is the additional evidence data to be requested, the start position (Address) of the software in the memory, the size (Size), and the number of times (Nesting depth) the additional evidence data was acquired.

In FIG. 14, the additional evidence collection instruction (Request ID (3): 1) designates the address 20306AB0h extracted by the address determination unit 211 as the start position and 4 KB as the size. Since the additional evidence data that is being requested is the first additional evidence data based on the evidence data, the number of times the additional evidence data was acquired is set to 1.

When the address determination unit 211 extracts a plurality of addresses, the additional evidence data acquisition range determination unit 212 determines an acquisition range based on each of the plurality of addresses. Thus, the additional evidence collection instruction generation unit 213 generates a plurality of additional evidence collection instructions including the respective acquisition ranges.

In the present embodiment, when the type of evidence data is an instruction, that is, when the address determination unit 211 disassembles the evidence data to acquire a plurality of addresses, the additional evidence collection instruction generation unit 213 generates additional evidence collection instructions in the order of the evidence data control flow. When the type of evidence data is a pointer, that is, when the address determination unit 211 sets a plurality of pointers to a plurality of addresses, the additional evidence collection instruction generation unit 213 generates additional evidence collection instructions in the order in which the pointers are placed in the memory.

When there are a plurality of types of data in the tampered portion, some of which are instructions and the rest are pointers, priority may be given to the address associated with the instruction or the address indicated by the pointer. When the additional evidence data is acquired a plurality of times, the address in the depth direction may be extracted preferentially, or the address in the width direction may be extracted preferentially. The depth direction refers to processing that proceeds while incrementing the number of acquisitions, and the width direction refers to processing that proceeds within the same number of acquisitions. When the address in the depth direction is extracted preferentially, the hook function can be reached more quickly. When the address in the width direction is extracted preferentially, a wide range of evidence data can be collected.

However, in the following cases, the additional evidence collection instruction generation unit 213 does not generate additional evidence collection instructions. That is, these cases are termination conditions, and the additional evidence collection instruction transmission unit 214 does not transmit additional evidence collection instructions.

First, if the acquisition range determined by the additional evidence data acquisition range determination unit 212 falls within the range where the integrity of the software has been verified using the measurement instruction, the additional evidence collection instruction generation unit 213 does not generate an additional evidence collection instruction. This is because the memory region is within the range where the integrity has already been verified.

Second, if the acquisition range determined by the additional evidence data acquisition range determination unit 212 falls within the range of evidence data or additional evidence data acquired in the past, the additional evidence collection instruction generation unit 213 does not generate an additional evidence collection instruction. This is because it is not necessary to acquire the same evidence data redundantly.

Third, if the number of times additional evidence data, for which the address is to be extracted by the address determination unit 211, was acquired is “equal to or greater than” a predetermined number of times, the additional evidence collection instruction generation unit 213 does not generate an additional evidence collection instruction. This is because it is necessary to prevent the analysis from continuing indefinitely due to a DoS attack.

The term “equal to or greater than” may refer to either including the predetermined number of times (≥) or not including the predetermined number of times (>).

The additional evidence collection instruction transmission unit 214 transmits, to the prover device 100, the additional evidence collection instruction generated by the additional evidence collection instruction generation unit 213.

The additional evidence data reception unit 215 receives additional evidence data from the prover device 100. Since examples of the additional evidence data are the same as examples of the evidence data in FIG. 10, FIG. 10 and the description thereof are cited.

The additional evidence data reception unit 215 outputs the received additional evidence data to the analysis unit 210. The analysis unit 210 analyzes the additional evidence data similarly to the analysis already described, and terminates the analysis when no more tampered portions are detected.

The additional evidence collection instruction transmission unit 214 and the additional evidence data reception unit 215 have the same functions as the evidence collection instruction transmission unit 208 and the evidence data reception unit 209, respectively, and thus may be combined into one block. That is, as illustrated in FIG. 5, the evidence collection instruction transmission unit 208 and the additional evidence collection instruction transmission unit 214, and the evidence data reception unit 209 and the additional evidence data reception unit 215 may each be implemented as one component or one program.

### (3) Operation of Verifier Device 200

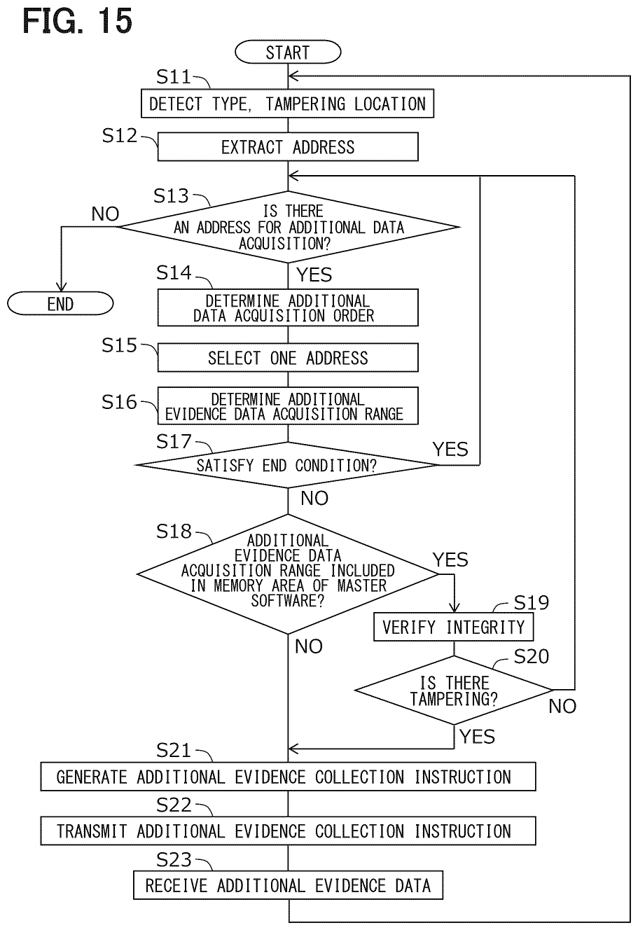

The operation of the verifier device 200 will be described with reference to FIG. 15. FIG. 15 illustrates not only a verification method executed by the verifier device 200 but also a processing procedure for a verification program executable by the verifier device 200. The processing to be described is not limited to the order indicated in FIG. 15. That is, the order may be interchanged unless there are restrictions, such as a relationship in which one step uses the result of its preceding step.

The analysis unit 210 of the verifier device 200 detects a type and a tampered portion of evidence data or additional evidence data (S11).

The address determination unit 211 extracts an address indicating a transition destination or a reference destination included in the evidence data or additional evidence data based on the type of data and the tampered portion detected in S11 (S12).

The additional evidence data acquisition range determination unit 212 confirms whether an address for which additional data is to be acquired exists or remains (S13). When there is no target address (S13: N), the process is terminated. When the target address exists or remains (S13: Y), the process proceeds to S14.

When there are a plurality of addresses for which additional data is to be acquired, the additional evidence data acquisition range determination unit 212 determines the order in which to acquire the additional data (S14). That is, the additional evidence collection instruction generation unit 213 determines the order in which to generate additional evidence collection instructions.

When there are a plurality of addresses for which additional data is to be acquired, the additional evidence data acquisition range determination unit 212 selects one of the addresses in the order determined in S14 (S15).

The additional evidence data acquisition range determination unit 212 determines an acquisition range of additional evidence data to be additionally collected based on the address selected in S15 (S16).

The additional evidence collection instruction generation unit 213 determines whether the acquisition range of the additional evidence data or the number of times the additional evidence data was acquired satisfies the termination condition (S17). When the termination condition is satisfied (S17: Y), the process returns to S13. When the termination condition is not satisfied (S17: N), the process proceeds to S18.

The additional evidence collection instruction generation unit 213 determines whether the additional evidence data acquisition range determined in S16 is included in the memory region of the master software (S18). For the memory region of the master software, it is sufficient to refer to information recorded in the measurement target table of FIGS. 6A and 6B, for example. When the program is not included in the memory region of the master software (S18: N), the process proceeds to S21. When the measurement instruction is included in the memory region of the master software (S18: Y), the measurement instruction generation unit 202 and the measurement instruction transmission unit 203 generate and transmit a measurement instruction, and the verification unit 206 performs integrity verification based on the measurement result received from the prover device 100 (S19). When tampering is detected (S20: Y), the process proceeds to S21. When tampering is not detected (S20: N), the process returns to S13.

The additional evidence collection instruction generation unit 213 generates an additional evidence collection instruction including the acquisition range determined in S16 (S21).

The additional evidence collection instruction transmission unit 214 transmits the additional evidence collection instruction generated in S21 to the prover device 100 (S22).

The additional evidence data reception unit 215 receives, from the prover device 100, additional evidence data that is a response corresponding to the additional evidence collection instruction transmitted in S22 (S23). The process returns to S11.

### (4) Summary

As described above, according to the verifier device 200 of the present embodiment, the address indicating the transition destination or the reference destination included in the evidence data is extracted and the acquisition range of the additional evidence data is determined based on the extracted address, so that evidence necessary and sufficient for analysis can be collected.

According to the present embodiment, since the address is extracted also for the acquired additional evidence data, and the acquisition range of the further additional evidence data is determined based on the extracted address, software being executed in a deeper layer can be acquired.

According to the present embodiment, since the type and tampered portion of evidence data and additional evidence data are analyzed and the address acquisition method is changed according to the type, the accuracy of hook detection can be improved.

According to the present embodiment, when a plurality of addresses are extracted, additional evidence data is acquired in the execution order of the software, enabling the analysis of the attack mechanism of the attacker along a time series.

According to the present embodiment, since the hooking function is collected as additional evidence data, it is possible to analyze what specific tampering or eavesdropping is being attempted by the hooking function.

According to the present embodiment, since the additional evidence data is stored in a memory region different from the evidence data, even regions that cannot be verified by integrity verification can be collected as additional evidence data.

### 3. Other Disclosures

Among the disclosures disclosed in the first embodiment, the disclosures belonging to the categories of the method and the program are shown below.

### (Disclosure of Verification Program)

A verification program that is executable by a verifier device in a remote attestation system comprising a prover device and a verifier device, when the verifier device transmits a measurement result in response to a measurement instruction from the verifier device, the verifier device transmits an evidence collection instruction for requesting evidence data in response to the measurement result from the verifier device, the verifier device transmits the evidence data in response to the evidence collection instruction from the verifier device, and the verifier device that has received the evidence data requests additional evidence data, the verification program causing the verifier device to execute the steps of:
determining, based on the evidence data, an address that identifies the position of the additional evidence data;
determining, based on the address, an acquisition range of the additional evidence data to be additionally collected;
generating an additional evidence collection instruction that includes the acquisition range;
transmitting the additional evidence collection instruction to the prover device; and
receiving the additional evidence data from the prover device.

### 4. General Remarks

The features of the verifier device, the verification method, the verification program, and the remote attestation system in each embodiment of the present disclosure have been described above.

Since the terms used in each embodiment are examples, these may be replaced with terms that are synonymous or include synonymous functions.

The block diagram used for the description of each embodiment is obtained by classifying and arranging the configuration of the device by function. The block showing each function is implemented by any combination of hardware and software. In addition, since the functions are shown, the block diagram can be understood as a disclosure of a method and a disclosure of a program to implement the method.

The order of the functional blocks that can be understood as the processing, the flow, and the method described in each embodiment may be changed unless there are restrictions, such as a relationship in which one step uses the result of another step in the preceding step.

The terms first, second, or N (N is an integer) used in each embodiment and the claims are used to distinguish between two or more configurations or methods of the same type and do not limit the order or superiority.

The following are examples of the forms of devices of the present disclosure.

Examples of the form of the component include a semiconductor element, an electronic circuit, a module, and a microcomputer.

Examples of the form of the semi-finished product include an electronic control device (electric control unit, ECU) and a system board.

Examples of the form of the finished product include a mobile phone, a smartphone, a tablet, a personal computer (PC), a workstation, and a server.

In addition, devices with communication functions, and the like are included, and examples thereof include a video camera, a still camera, and a car navigation system.

To each device, necessary functions such as an antenna and a communication interface may be added.

The verifier device of the present disclosure is assumed to be used for the purpose of providing various services, especially when used on the server side. With the provision of such services, the verifier device of the present disclosure will be used, the verification method of the present disclosure will be used, and/or the verification program of the present disclosure will be executed.

In addition, the present disclosure can be implemented not only with dedicated hardware configured and functioning as described in each embodiment, but also through a combination of a program, recorded in a recording medium such as memory or a hard disk, for realizing the present disclosure with general-purpose hardware, including a dedicated or general-purpose CPU, memory, and the like, capable of executing the program.

The program stored in a non-transitory tangible recording medium (e.g., an external storage device (hard disk, USB memory, CD/BD, etc.) or an internal storage device (RAM, ROM, etc.)) of dedicated or general-purpose hardware can also be provided to dedicated or general-purpose hardware via a recording medium, or from a server via a communication line without a recording medium. As a result, it is possible to always provide the latest functions through program upgrade.

The present disclosure has mainly described the case where an in-vehicle electronic control device mounted in an automobile is used as a prover device. However, the present disclosure can be applied to all moving objects such as motorcycles, ships, trains, and aircraft. The present disclosure is applicable not only to moving objects but also to all products including microcomputers.

### (Examples of the Technical Concepts Disclosed Herein)

### (Item 1)

A verifier device in a remote attestation system including a prover device and the verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, and the verifier device that has received the evidence data requests additional evidence data, the verifier device including:
an address determination unit that determines an address specifying a position of the additional evidence data based on the evidence data;
an additional evidence data acquisition range determination unit that determines an acquisition range of the additional evidence data to be additionally collected based on the address;
an additional evidence collection instruction generation unit that generates an additional evidence collection instruction including the acquisition range;
an additional evidence collection instruction transmission unit that transmits the additional evidence collection instruction to the prover device; and
an additional evidence data reception unit that receives the additional evidence data from the prover device.

### (Item 2)

The verifier device according to item 1, wherein
the address determination unit determines the address by extracting the address indicating a transition destination or a reference destination included in the evidence data.

### (Item 3)

The verifier device according to item 2, wherein
the address determination unit determines the address by extracting the address included in the additional evidence data received by the additional evidence data reception unit.

### (Item 4)

The verifier device according to item 3, further including
an analysis unit that analyzes a type and tampered location of the evidence data or the additional evidence data,
wherein:
when the type of the evidence data or the additional evidence data at the tampered location is an instruction, the address determination unit disassembles the evidence data or the additional evidence data to obtain the address; and
when the type of the evidence data or the additional evidence data at the tampered location is a pointer, the address determination unit uses the pointer as the address.

### (Item 5)

The verifier device according to item 4, wherein
when the address determination unit extracts a plurality of addresses and when the plurality of addresses are obtained by disassembling the evidence data, the additional evidence collection instruction generation unit generates the additional evidence collection instruction in an order of a control flow of the evidence data, and
when the address determination unit extracts a plurality of addresses and when the plurality of addresses are obtained by using a plurality of pointers, the additional evidence collection instruction generation unit generates the additional evidence collection instruction in an order in which the pointers are arranged in a memory.

### (Item 6)

The verifier device according to item 1, wherein
the additional evidence data acquisition range determination unit uses the address as a start point of the acquisition range, and uses either a value obtained by adding a predetermined size to the address, or an end point of a memory management area including the address, as an end point of the acquisition range.

### (Item 7)

The verifier device according to item 1, wherein
the additional evidence data acquisition range determination unit uses a start point of a memory management area including the address as a start point of the acquisition range, and uses an end point of the memory management area including the address as an end point of the acquisition range.

### (Item 8)

The verifier device according to item 1, wherein
the additional evidence collection instruction generation unit refrains from generating the additional evidence collection instruction when the acquisition range determined by the additional evidence data acquisition range determination unit is included in a range in which integrity of software has been verified using the measurement instruction.

### (Item 9)

The verifier device according to item 1, wherein
the additional evidence collection instruction generation unit refrains from generating the additional evidence collection instruction when the acquisition range determined by the additional evidence data acquisition range determination unit is included in a range of the evidence data or the additional evidence data acquired in past.

### (Item 10)

The verifier device according to item 3, wherein
the additional evidence collection instruction generation unit refrains from generating the additional evidence collection instruction when a total number of times the additional evidence data, which is a target for extracting the address by the address determination unit, has been acquired is equal to or greater than a predetermined number.

### (Item 11)

The verifier device according to item 1, wherein
the address is an address of a hooking function called by a hook.

### (Item 12)

The verifier device according to item 1, wherein
the additional evidence data is placed in a memory region different from that of the evidence data in the prover device.

### (Item 13)

The verifier device according to item 11, wherein
the additional evidence data is placed in a memory region dynamically allocated by an attack on the prover device.

### (Item 14)

The verifier device according to any one of items 1 to 13, wherein
the verifier device is a server device installed outside a mobile object.

### (Item 15)

The verifier device according to any one of items 1 to 13, wherein
the verifier device is an electronic control device mounted in a mobile object.

What is claimed is:

1. A verifier device in a remote attestation system comprising a prover device and the verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, and the verifier device that has received the evidence data requests additional evidence data, the verifier device comprising:
an address determination unit that determines an address specifying a position of the additional evidence data based on the evidence data;
an additional evidence data acquisition range determination unit that determines an acquisition range of the additional evidence data to be additionally collected based on the address;
an additional evidence collection instruction generation unit that generates an additional evidence collection instruction including the acquisition range;
an additional evidence collection instruction transmission unit that transmits the additional evidence collection instruction to the prover device; and
an additional evidence data reception unit that receives the additional evidence data from the prover device.

2. The verifier device according to claim 1, wherein
the address determination unit determines the address by extracting the address indicating a transition destination or a reference destination included in the evidence data.

3. The verifier device according to claim 2, wherein
the address determination unit determines the address by extracting the address included in the additional evidence data received by the additional evidence data reception unit.

4. The verifier device according to claim 3, further comprising
an analysis unit that analyzes a type and tampered location of the evidence data or the additional evidence data,
wherein:
when the type of the evidence data or the additional evidence data at the tampered location is an instruction, the address determination unit disassembles the evidence data or the additional evidence data to obtain the address; and
when the type of the evidence data or the additional evidence data at the tampered location is a pointer, the address determination unit uses the pointer as the address.

5. The verifier device according to claim 4, wherein
when the address determination unit extracts a plurality of addresses and when the plurality of addresses are obtained by disassembling the evidence data, the additional evidence collection instruction generation unit generates the additional evidence collection instruction in an order of a control flow of the evidence data, and
when the address determination unit extracts a plurality of addresses and when the plurality of addresses are obtained by using a plurality of pointers, the additional evidence collection instruction generation unit generates the additional evidence collection instruction in an order in which the pointers are arranged in a memory.

6. The verifier device according to claim 1, wherein
the additional evidence data acquisition range determination unit uses the address as a start point of the acquisition range, and uses either a value obtained by adding a predetermined size to the address, or an end point of a memory management area including the address, as an end point of the acquisition range.

7. The verifier device according to claim 1, wherein
the additional evidence data acquisition range determination unit uses a start point of a memory management area including the address as a start point of the acquisition range, and uses an end point of the memory management area including the address as an end point of the acquisition range.

8. The verifier device according to claim 1, wherein
the additional evidence collection instruction generation unit refrains from generating the additional evidence collection instruction when the acquisition range determined by the additional evidence data acquisition range determination unit is included in a range in which integrity of software has been verified using the measurement instruction.

9. The verifier device according to claim 1, wherein
the additional evidence collection instruction generation unit refrains from generating the additional evidence collection instruction when the acquisition range determined by the additional evidence data acquisition range determination unit is included in a range of the evidence data or the additional evidence data acquired in past.

10. The verifier device according to claim 3, wherein
the additional evidence collection instruction generation unit refrains from generating the additional evidence collection instruction when a total number of times the additional evidence data, which is a target for extracting the address by the address determination unit, has been acquired is equal to or greater than a predetermined number.

11. The verifier device according to claim 1, wherein
the address is an address of a hooking function called by a hook.

12. The verifier device according to claim 1, wherein
the additional evidence data is placed in a memory region different from that of the evidence data in the prover device.

13. The verifier device according to claim 11, wherein
the additional evidence data is placed in a memory region dynamically allocated by an attack on the prover device.

14. The verifier device according to claim 1, wherein
the verifier device is a server device installed outside a mobile object.

15. The verifier device according to claim 1, wherein
the verifier device is an electronic control device mounted in a mobile object.

16. A remote attestation system comprising:
a prover device; and
a verifier device,
wherein:
the prover device is a device that places and executes software in a memory, comprising:
a measurement instruction reception unit that receives a measurement instruction from the verifier device;
a measurement unit that reads the software placed in the memory and calculates a measurement value based on the measurement instruction;
a measurement result transmission unit that transmits the measurement value as a measurement result to the verifier device;
an evidence collection instruction reception unit that receives an evidence collection instruction generated by the verifier device based on the measurement result;
an evidence data collection unit that collects evidence data based on the evidence collection instruction;
an evidence data transmission unit that transmits the evidence data to the verifier device;
an additional evidence collection instruction reception unit that receives an additional evidence collection instruction generated by the verifier device based on the evidence data;
an additional evidence data collection unit that collects additional evidence data based on the additional evidence collection instruction; and
an additional evidence data transmission unit that transmits the additional evidence data to the verifier device;
the verifier device is a device that verifies integrity of the software executed by the prover device, comprising:
a measurement instruction generation unit that generates the measurement instruction;
a measurement instruction transmission unit that transmits the measurement instruction to the prover device;
a measurement result reception unit that receives the measurement result from the prover device;
an evidence collection instruction generation unit that generates the evidence collection instruction requesting the evidence data based on the measurement result;
an evidence collection instruction transmission unit that transmits the evidence collection instruction to the prover device;
an evidence data reception unit that receives the evidence data from the prover device;
an address determination unit that determines an address specifying a position of the additional evidence data based on the evidence data;
an additional evidence data acquisition range determination unit that determines an acquisition range of the additional evidence data to be additionally collected based on the address;
an additional evidence collection instruction generation unit that generates the additional evidence collection instruction including the acquisition range;
an additional evidence collection instruction transmission unit that transmits the additional evidence collection instruction to the prover device; and
an additional evidence data reception unit that receives the additional evidence data from the prover device.

17. The remote attestation system according to claim 16, wherein
the measurement value includes a hash value.

18. A verification method executed by a verifier device in a remote attestation system comprising a prover device and a verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, and the verifier device that has received the evidence data requests additional evidence data, the verification method comprising:
determining an address specifying a position of the additional evidence data based on the evidence data;
determining an acquisition range of the additional evidence data to be additionally collected based on the address;
generating an additional evidence collection instruction including the acquisition range;
transmitting the additional evidence collection instruction to the prover device; and
receiving the additional evidence data from the prover device.
